(19) United States
(12) Patent Application Publication
(10) Pub. No.: US 2008/0197813 A1
(43) Pub. Date: Aug. 21, 2008

(54) METHOD FOR QUICK-CHARGING NON-AQUEOUS ELECTROLYTIC SECONDARY BATTERY AND ELECTRIC EQUIPMENT USING THE SAME

(76) Inventors: Jun ASAKURA, Osaka (JP); Hajime NISHINO, Nara (JP); Masato FUJIKAWA, Osaka (JP)

Correspondence Address: MCDERMOTT WILL & EMERY LLP, 600 13TH STREET, NW, WASHINGTON, DC, 20005-3096, US

(21) Appl. No.: 12/034,098

(22) Filed: Feb. 20, 2008

(30) Foreign Application Priority Data
Feb. 20, 2007 (JP) 2007-039499

(51) Int. Cl. H02J 7/04

(52) U.S. Cl. 320/150

(57) ABSTRACT

A non-aqueous electrolytic secondary battery which includes a heat-resistant layer formed by a porous protective film or the like having a resin binder and an inorganic oxide filler between its negative electrode and a positive electrode has such a characteristic that the higher the battery's temperature becomes, the smaller its internal resistance value becomes. In a CC-CV charging method as a general method for charging a secondary battery, using such a characteristic that the internal resistance value of the non-aqueous electrolytic secondary battery lowers as the battery's temperature rises, a VC-charge range where a charge is given using an optimum charging-current value at a maximum level up to which the battery's temperature does not reach an excessive temperature even if a charging current flows is provided within a CC-charge range.

### BACKGROUND OF THE INVENTION

1. Field of the Invention

The present invention relates to a method for quick charging a non-aqueous electrolytic secondary battery which includes a heat-resistant layer formed by a porous protective film having a resin binder and an inorganic oxide filler between a negative electrode and a positive electrode thereof, and electric equipment provided with this.

2. Description of the Background Art

A non-aqueous electrolytic secondary battery which includes a heat-resistant layer formed by a porous protective film having a resin binder and an inorganic oxide filler between a negative electrode and a positive electrode thereof is described, for example, in Japanese Patent No. 3371301 specification. According to such a structure, while being manufactured, even if an active material which has peeled off the electrodes, a chip in a cutout process or the like adheres to the surfaces of the electrodes, then an internal short-circuit is restrained from being produced.

Herein, a charging method for a lithium-ion secondary battery according to a typical prior art is shown, for example, in FIG. 7. Specifically, for example, an electric current value which allows a battery in a full-charge state to discharge in an hour is set to 1 Iₜ. In this case, using an electric current of approximately 0.7 to 1 Iₜ, a CC (or constant current) charge is given up to a predetermined charge finish voltage Vf, for example, 4.2 volts. After the voltage comes to this charge finish voltage Vf, the charge switches normally to a CV (or constant voltage) charge in which the charging current is reduced so that the charge finish voltage Vf can be maintained.

In a general lithium-ion secondary battery, its internal resistance value depends slightly upon the temperature. On the other hand, in the non-aqueous electrolytic secondary battery having the above described structure, it is found out that the internal resistance value varies according to the temperature. Using this characteristic, therefore, the inventors of the present invention invents a method for giving a quicker charge. Specifically, in an ordinary lithium-ion secondary battery, as shown in FIG. 7, the CC charge with keeping the charging current value constant is given until the voltage reaches the charge finish voltage Vf. While being charged, the lithium-ion secondary battery's internal resistance value changes hardly. This is the reason why the charging current value is kept constant. In contrast, in the non-aqueous electrolytic secondary battery having the above described structure, as the battery's temperature rises, the internal resistance value decreases. Because of this characteristic, in this non-aqueous electrolytic secondary battery, the battery temperature usually rises during charging, and the charging current value is increased in line with a reduction in the internal resistance value caused by the battery temperature's rise. This makes it possible to drastically shorten the charging time taken until the voltage reaches the charge finish voltage Vf.

### SUMMARY OF THE INVENTION

It is an object of the present invention to provide a method for quick charging a non-aqueous electrolytic secondary battery and electric equipment which are capable of shortening the time taken for a charge in the non-aqueous electrolytic secondary battery which includes a heat-resistant layer between a negative electrode and a positive electrode thereof.

A method for quick charging a non-aqueous electrolytic secondary battery according to an aspect of the present invention, in the non-aqueous electrolytic secondary battery which includes a heat-resistant layer between a negative electrode and a positive electrode thereof, comprising the steps of: (a) detecting the temperature of the secondary battery; (b) obtaining an internal resistance value of the secondary battery which corresponds to the detected temperature of the secondary battery; (c) based on the detected temperature of the secondary battery and the obtained internal resistance value of the secondary battery, obtaining, as an optimum charging-current value, a maximum charging-current value up to which the temperature of the secondary battery does not reach an excessive temperature even if a charging current flows to the secondary battery; and (d) supplying an electric current equivalent to the obtained optimum charging-current value to the secondary battery.

According to this configuration, for example, in a method for charging a secondary battery such as a lithium-ion battery where as a standard, a CC (or constant current) charge is given up to a predetermined charge finish voltage Vf and the charge switches to a CV (or constant voltage) charge after the voltage comes to the charge finish voltage Vf, in order to realize a quick charge, the charging current value within such a CC range as described above is set to an optimum charging-current value which varies according to the temperature of the secondary battery. Then, the non-aqueous electrolytic secondary battery which includes a heat-resistant layer formed by a porous protective film or the like having a resin binder and an inorganic oxide filler between a negative electrode and a positive electrode thereof has such a characteristic that the higher its temperature becomes, the smaller the internal resistance value becomes. Hence, based on the secondary battery's temperature which is actually detected, the above described optimum charging-current value is set to a maximum charging-current value up to which it does not reach an excessive temperature even if the charging current flows to the secondary battery. This helps prevent the secondary battery's temperature from reaching the excessive temperature, as well as shorten the charging time. Even if the secondary battery is degraded, and thus, its internal resistance value varies according to each temperature, then the same behavior can be obtained. Consequently, the time taken for the charge can be shortened by executing similar control.

These and other objects, features and advantages of the present invention will become more apparent upon reading of the following detailed description along with the accompanied drawings.

### BRIEF DESCRIPTION OF THE DRAWINGS

FIG. 1 is a block diagram, showing the electrical configuration of electric equipment according to a first embodiment of the present invention.

FIG. 2 is a graphical representation, showing a correlation between the temperature and the internal resistance value of a non-aqueous electrolytic secondary battery which includes a heat-resistant layer formed by a porous protective film having a resin binder and an inorganic oxide filler between a negative electrode and a positive electrode thereof.

FIGS. 3A and 3B are each a graphical representation, showing a charging method according to the first embodiment of the present invention.

FIG. 4 is a flow chart, showing a charging operation in the electric equipment according to the first embodiment of the present invention.

FIG. 5 is a flow chart, showing a charging operation in electric equipment according to a second embodiment of the present invention.

FIG. 6 is a graphical representation, showing a correlation between an SOC and an internal resistance value.

FIG. 7 is a graphical representation, showing a charging method according to a prior art.

### DESCRIPTION OF THE PREFERRED EMBODIMENTS

Hereinafter, embodiments of the present invention will be described with reference to the attached drawings. In each figure described below, the same or similar component elements are given the same or similar reference characters and numerals, and thus, their description can be omitted.

### First Embodiment

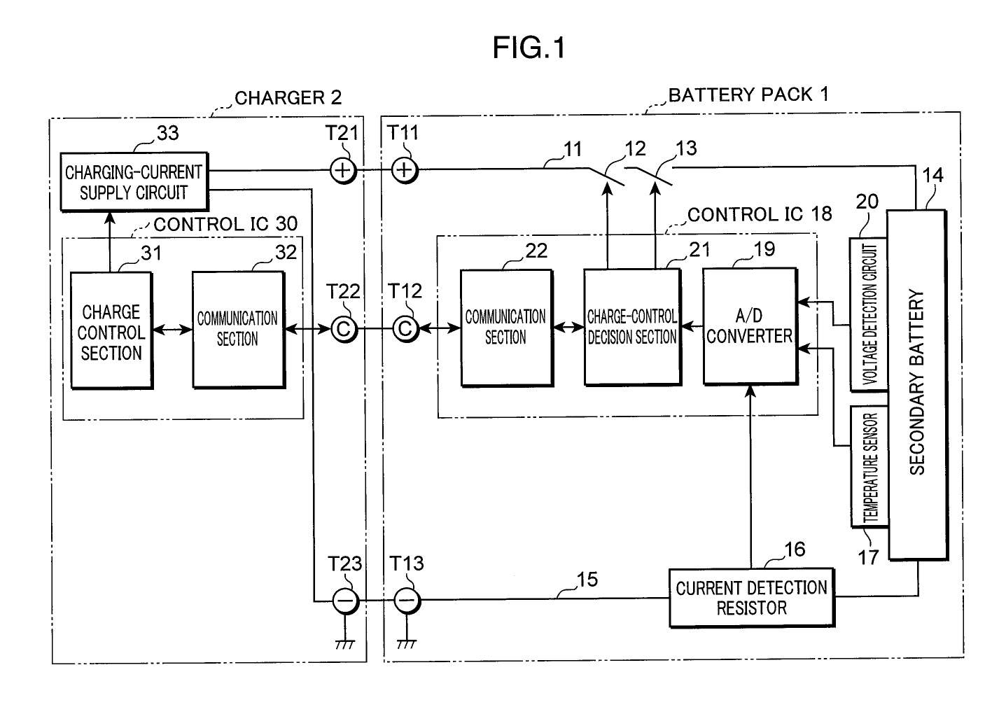

FIG. 1 is a block diagram, showing the electrical configuration of electric equipment according to a first embodiment of the present invention. The electric equipment according to this embodiment includes a battery pack 1, a charger 2 which charges the battery pack 1, and load equipment (not shown). The battery pack 1 is charged by the charger 2. In addition, the battery pack 1 may also be attached to the load equipment so as to be charged through the load equipment. The battery pack 1 and the charger 2 are mutually connected via terminals T11 and T21 for power supply on the DC-high side, terminals T12 and T22 for a communication signal, and GND terminals T13 and T23 for power supply and a communication signal. Likewise in the case where the above described load equipment is provided, the same terminals are provided.

Inside of the battery pack 1, FETs 12 and 13 for charge and discharge which are different from each other in the form of electrical conduction lie midway on a charge-and-discharge path 11 on the DC-high side extending from the terminal T11. This charge-and-discharge path 11 is connected to the high-side terminal of a secondary battery 14. The secondary battery 14's low-side terminal is connected via a charge-and-discharge path 15 on the DC-low side to the GND terminal T13. On this charge-and-discharge path 15, a current detection resistor 16 which converts a charging current and a discharging current into voltage values is disposed in its middle.

The secondary battery 14 includes one or several cells connected in series-parallel. As given in Japanese Patent No. 3371301 specification described earlier, this secondary battery 14 includes a heat-resistant layer formed by a porous protective film having a resin binder and an inorganic oxide filler between its negative electrode and positive electrode. The inorganic oxide filler is chosen from alumina powder or SiO₂ powder (i.e., silica) which has a particle diameter of 0.1 to 50 μm. The thickness of the porous protective film is set to 0.1 to 200 μm. This porous protective film is formed by coating at least either of the surfaces of the negative electrode and the positive electrode with a minute-particle slurry including the above described resin binder and inorganic oxide filler. Such a secondary battery is used, and thus, even if metallic lithium is deposited like a tree in an overcharge state, the above described heat-resistant layer is helpful in preventing the deposited metallic lithium from short-circuiting the negative electrode and the positive electrode. The secondary battery 14 like this is especially desirable for the quick charge according to this embodiment.

The secondary battery 14's cell temperature is detected by a temperature sensor 17 and inputted in an analog-digital converter 19 inside of a control IC 18. Further, the voltage between the terminals of each cell is read by a voltage detection circuit 20. Then, it is inputted in the analog-digital converter 19 of the control IC 18. Still further, a current value detected by the current detection resistor 16 is also inputted in the analog-digital converter 19 of the control IC 18. The analog-digital converter 19 converts each input value into a digital value and outputs it to a charge-control decision section 21.

The charge-control decision section 21 is formed by a microcomputer, its peripheral circuits and the like. It calculates a residual amount (i.e., an SOC) in response to each input value from the analog-digital converter 19. Then, it transmits, from a communication section 22 via the terminals T12, T22; T13, T23 to the charger 2, whether or not there is an abnormality in each cell temperature, and charging voltage and current values which it requests to the charger 2. If charge and discharge are normal, the charge-control decision section 21 turns on the FETs 12 and 13 so that the charge and the discharge can be permitted. On the other hand, if any abnormality is detected, it turns off them so that the charge and the discharge cannot be permitted.

In the charger 2, the above described temperature or abnormality existence and the requested charging voltage and current values are received by a communication section 32 of a control IC 30. A charge control section 31 controls a charging-current supply circuit 33, so that a charging current is supplied at those voltage value and current value. The charging-current supply circuit 33 is made up of an AC-DC converter, a DC-DC converter and the like. It converts an input voltage into arbitrary voltage and current values, and then, they are supplied through the terminals T21, T11; T23, T13 to the charge-and-discharge paths 11, 15.

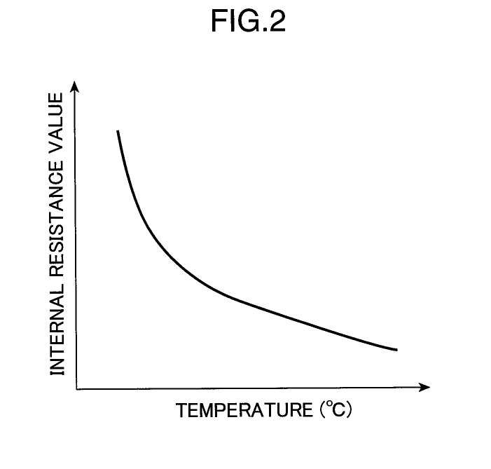

In the electric equipment according to this embodiment, when the secondary battery 14 is quickly charged, the charge control section 31 which corresponds to the charge control section receives the cell temperature detected by the temperature sensor 17 via the communication sections 32 and 22 which correspond to the battery-temperature acquisition section. Then, for example, as shown in FIG. 2, based on the secondary battery 14's internal resistance value which lowers as a temperature T rises, the charge control section 31 obtains, as the optimum charging-current value, a maximum charging-current value up to which its temperature does not reach an excessive temperature even when its charging current flows. It sets this value in the charging-current supply circuit 33 which corresponds to the charge control section, and an electric current equivalent to the obtained optimum charging-current value is supplied to the secondary battery 14.

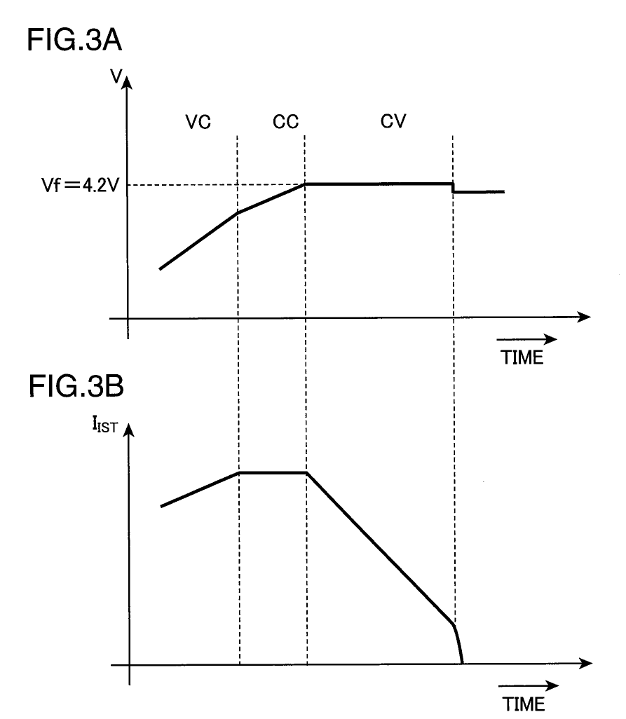

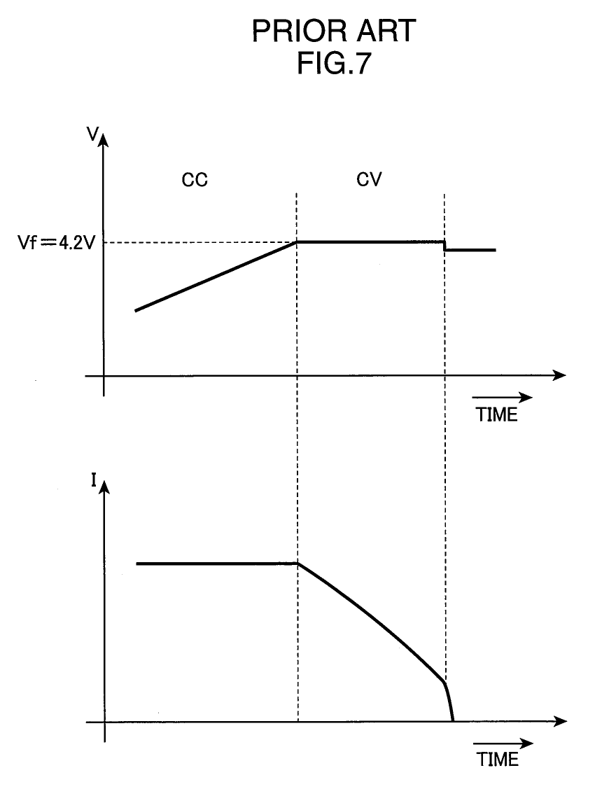

In other words, as shown in FIGS. 3A and 3B, the range of a VC (or variable current) charge where a charge is given at the above described maximum charging-current value up to which it does not reach an excessive temperature is newly included within the range of a conventional CC (or constant current) charge. In the same way as FIG. 7 shown earlier, FIG. 3A is a graphical representation, showing a variation in cell voltage and FIG. 3B is a graphical representation, showing a variation in charging current. In FIG. 3A, for the purpose of simplify the figure, the charging current value is raised within the above described VC-charge range, and if the cell temperature rises, it shifts to the CC-charge range where this charging current value is maintained so that it will not come to the excessive temperature. It is a matter of course that these two charge ranges can be frequently switched suitably according to the variation in the cell temperature.

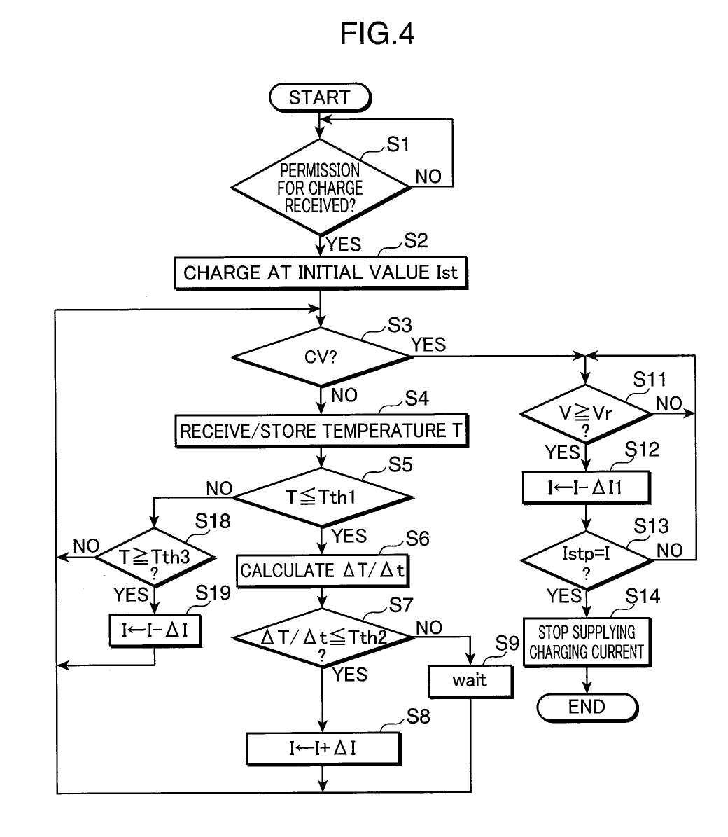

FIG. 4 is a flow chart, detailing such a charging operation by the charge control section 31. In a step Si, the charge control section 31 waits for permission for a charging voltage Vr and a charging current Ir from the charge-control decision section 21 on the side of the battery pack 1. If it receives permission for the charging voltage Vr and the charging current Ir after the battery pack 1 is attached to the charger 2, thereafter, it gives a charge within this permission. If a charging current equal to, or above, the permitted current Ir flows, the charge-control decision section 21 turns off the FETs 12 and 13 while sending an alarm to the charge control section 31.

First, in a step S2, a predetermined initial value Ist as a charging current value I to be supplied is set in the charging-current supply circuit 33, and the charging operation starts. At the point of time when the charge begins, the permitted voltage Vr of the battery pack 1 is the above described charge finish voltage Vf, for example, 4.2 volts, and the permitted current Ir is a maximum current Imax, for example, 1 Iₜ.

In a step S3, a decision is made whether or not the battery pack 1's operation has come into the range of a CV charge. If it has not come into the CV-charge range, the processing goes ahead to a step S4 and its following. Then, a quick-charge operation described below according to this embodiment is conducted within the above described VC or CC charge range. On the other hand, if it has come into the CV-charge range, the processing moves to a step S11 and its succeeding ones. Then, such a charging operation as executed conventionally is conducted within this CV-charge range. Incidentally, the decision that the operation has come into the CV-charge range can be made from the fact that the outputted charging voltage has reached the permitted voltage Vr.

In a step S4, data on the cell temperature T from the battery pack 1 is received and stored. In a step S5, a decision is made whether or not the received cell temperature T is equal to, or lower than, a predetermined halt temperature Tth1 for halting the quick charge. If it is equal to, or lower than, the halt temperature Tth1, then the processing shifts to a step S6 and its following to give the quick charge. In a step S6, using the stored data on the cell temperature T, the difference between the data at a specific time and the data earlier by a predetermined time Δt than the specific time, or a temperature-rise rate ΔT/Δt is calculated. In a step S7, a decision is made whether or not the calculated temperature-rise rate ΔT/Δt is equal to, or lower than, a predetermined value Tth2. If it is equal to, or lower than, the value Tth2, then in a step S8, to the charging current value I supplied at present, a predetermined increment ΔI is added to increase the charging current value I. After this, the processing returns to the above described step S3. On the other hand, in the step S7, if the temperature-rise rate ΔT/Δt is beyond the value Tth2, the processing stands by for a predetermined period in a step S9, and then, returns to the step S3.

Therefore, upon returning to the step S3 from the step S8, the VC charge is given, while the CC charge is given upon returning to the step S3 from the step S9. In this way, the processing of the step S4 to the step S8 is repeated, so that the charging current value I becomes the above described optimum charging-current value which is the maximum charging-current value up to which the temperature does not reach the excessive temperature.

On the other hand, if it shifts to the CV charge in the step S3, then in a step S11, a decision is made whether a charging voltage V in supply is higher than the permitted voltage Vr from the battery pack 1. If it is higher, then in a step S12, the charging current value I is reduced by subtracting a predetermined decrement ΔI1 from the charging current value I. Thereafter, in a step S13, a decision is made whether or not this charging current value I has been reduced up to a predetermined value Istp infinitely close to zero for stopping supplying the charging current, for example, 10 mA. If it has been reduced up to it, the charge control section 31 decides that it is fully charged. In a step S14, it stops supplying the charging current I, and if an indicator or the like is provided, it makes a full-charge display to end the processing. In the step S13, if I is not equal to Istp, in other words, if there is still permission for the charging current, the processing returns to the above described step S11.

In addition, in the above described step S5, if the received cell temperature T is higher than the halt temperature Tth1, then in a step S18, further, a decision is made whether it is equal to, or higher than, an excessive temperature Tth3 for deciding on an excessive-temperature state in which the charging current value I should be lowered. If it has not reached the excessive temperature Tth3, the processing returns to the above described step S3 and the charging current value I at present is maintained. In contrast, if it has reached the excessive temperature Tth3, then in a step S19, the above described increment ΔI is subtracted from the charging current value I at present to urgently decrease the charging current value I. Afterward, the processing returns to the step S3.

According to this configuration, in the case where the secondary battery 14 is formed, as described above, by a non-aqueous electrolytic secondary battery which includes a heat-resistant layer between its negative electrode and positive electrode and has such a characteristic that its internal resistance value lowers as the temperature T rises, a charge is given with a large electric current, using an internal resistance value lowered at a temperature at which a PTC protective device or such another comes into operation, extremely close to the temperature at which the state turns into an excessive-temperature state. This makes it possible to shorten the charging time.

Furthermore, the above described optimum charging-current value is obtained when the detected temperature T is equal to, or lower than, the temperature Tth1 for halting the quick charge as well as the temperature-rise rate ΔT/Δt caused by the charge is equal to, or lower than, the predetermined value Tth2. In addition, it is obtained by repeating the operation in which the predetermined increment ΔI is added to the charging current value I at that time so that it can be updated. The above described temperature decision and temperature-rise rate decision are made, so that even if the charging current flows, the temperature can be kept down so as not to reach the excessive temperature. Besides, the step of updating the optimum charging-current value is taken, so that the charging current value I can be raised to such a maximum level. Therefore, as described above, the maximum charging-current value up to which it does not come to the excessive temperature even if the charging current flows can be obtained as the optimum charging-current value.

Furthermore, even if the secondary battery 14 is degraded, and thus, its internal resistance value varies according to each temperature, then the same behavior can be obtained. Consequently, the above described control of FIG. 4 can be used as it is. In addition, the above described explanation, the charging current value I is increased by the increment ΔI at each time, and using data on the temperature T based on this, the optimum charging-current value for evading the excessive temperature is sought. Besides, this optimum charging-current value may also be held in a table or the like which is create so as to correspond to the temperature, so that necessary data at a data point can be suitably obtained through interpolation arithmetic or the like. Or, using a numerical formula or the like in which a coefficient or the like is set in advance, it can be obtained by making calculations one by one. In this case, the actual charging current value I can be swiftly set to the optimum charging-current value. On the other hand, if the optimum charging-current value is searched for by increasing the charging current value I gradually, that can also be applied to the above described degradation or the like. These methods of setting the optimum charging-current value may be appropriately chosen.

Moreover, in this embodiment, the analog-digital converter 19 is mounted on the side of the battery pack 1, and via the communication sections 22 and 32, information on the battery temperature or the battery voltage flows to the charge control section 31 on the side of the charger 2. However, the charge control section 31 may directly read the battery temperature and battery voltage of the battery pack 1 by mounting an analog-digital converter in the charge control section 31. Besides, in this embodiment, the charge control section 31 is provided in the charger 2 which is a separate body from the battery pack 1. But the battery pack 1 and the charge control section 31 may also be united so that a battery pack can be formed with a charge control function.

### Second Embodiment

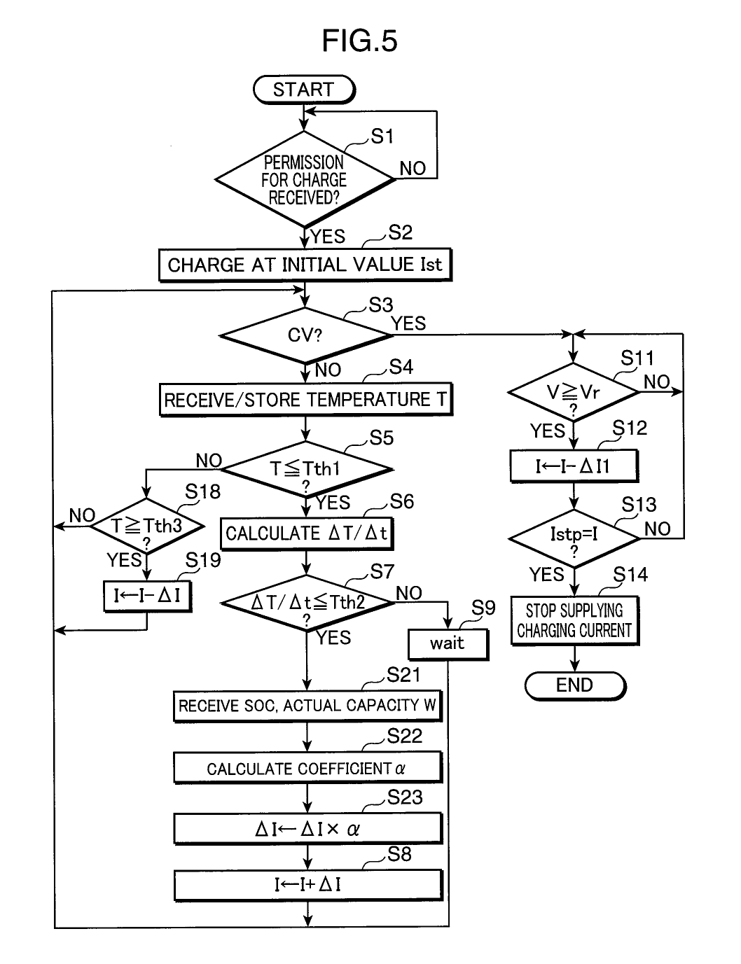

FIG. 5 is a flow chart, showing a charging operation in electric equipment according to a second embodiment of the present invention. In this embodiment, the above described configuration of the electric equipment shown in FIG. 1 can be used. In this processing of FIG. 5, the parts similar and correspond to the above described processing of FIG. 4 are given the same step numbers, and thus, their description is omitted. In this embodiment, the above described increment ΔI is determined by considering not only the above described cell temperature T and its temperature-rise rate ΔT/Δt, but also a terminal voltage V1 and an actual capacity W of the secondary battery 14.

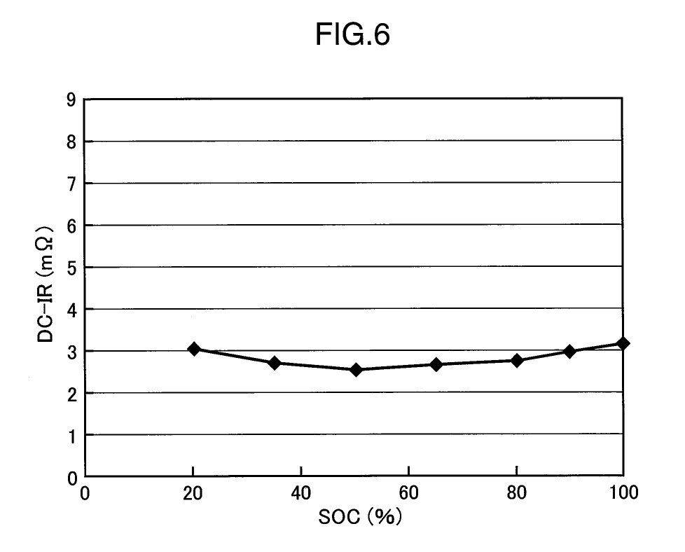

As shown in FIG. 2, the above described internal resistance value becomes smaller as the temperature rises, as well as it varies according to the SOC (or state of charge), as shown in FIG. 6. Besides, as the second battery 14 is repeatedly charged and discharged and thereby is degraded, the internal resistance value becomes higher. Hence, before the charging current value I is updated in the step S8, in a step S21, the charge control section 31 also takes in data on the SOC (equal to the terminal voltage V1) which is integrated by the charge-control decision section 21 and data on the actual capacity (Ah in the full-charge state) W (equal to the degradation level) reduced through the repeat of charge and discharge which is managed by the charge-control decision section 21. Then, in a step S22, a table in which these pieces of data are stored beforehand as parameters is read, or after a table which corresponds to either of the pieces of data as a parameter is read, the read value is corrected using the other parameter. Through such a operation, a coefficient α for correcting the increment ΔI is obtained. With this coefficient α, using the increment ΔI corrected in a step S23, the charging current value I is updated in the step S8.

In this way, the optimum charging-current value is corrected using the cumulative values of the lapse of time, number of charges and discharges, charge-and-discharge capacity and the like after the secondary battery 14 is manufactured, or the secondary battery 14's degradation level obtained by actually measuring an OCV and a CCV or through another such operation as well as the measured terminal voltage V1. This makes it possible to shorten the charging time more precisely.

Herein, Japanese Patent Laid-Open No. 9-107638 specification comes up with a charge control method in which if a variation in temperature per predetermined time or a temperature differential value during a charge in a CC mode is equal to, or below, a predetermined value, then a charge finish voltage in a CV mode is set to a value which corresponds to the temperature at that time. According to this charge control method, even if the ambient temperature varies sharply in the case where it is brought indoors from the outdoors or another such case, the charge finish voltage in the CV mode can be suitably reconsidered and properly set. This helps prevent an overcharge and charge it fully.

However, in this prior art, the temperature of a secondary battery is detected, and feedback control is executed. This is because the secondary battery's terminal voltage (i.e., the voltage of a cell itself) varies significantly according to its temperature. Hence, in this prior art, the variation in the internal resistance value according to the temperature is not used, different from the present invention. Besides, its object is to bring the secondary battery into a full charge, also different from the present invention which has an object of realizing a quick charge.

Furthermore, in Japanese Patent Laid-Open No. 2005-245078 specification, in a circuit for giving a charge using electro-magnetic induction, if the heat produced through electro-magnetic induction is about to raise the temperature of a secondary battery beyond its allowable temperature, the charging current is controlled so as to be a charging current value which corresponds to the temperature at that time. Thereby, in such an electro-magnetic induction charging circuit, a charge can be given in a short period of time under a high-temperature environment.

However, in this prior art, although the feedback control of the charging current is executed according to the temperature, this temperature depends upon electro-magnetic induction. Hence, its relation with the internal resistance is not used, different from the present invention.

As described so far, in the method for giving a quick charge to a non-aqueous electrolytic secondary battery and the electric equipment provided with this according to the first and second embodiments of the present invention, when a quick charge is given to a secondary battery such as a lithium-ion battery where a CC-CV charge is given as a standard, in the case where the non-aqueous electrolytic secondary battery is used which includes a heat-resistant layer formed by a porous protective film or the like having a resin binder and an inorganic oxide filler between its negative electrode and a positive electrode, this secondary battery has such a characteristic that the higher its temperature becomes, the smaller the internal resistance value becomes. Therefore, based on the secondary battery's temperature, the charging current value within the above described CC range is set to the optimum charging-current value at the maximum level up to which it does not reach the excessive temperature even if the charging current flows. This helps prevent the secondary battery's temperature from reaching the excessive temperature, as well as shorten the charging time.

Furthermore, in the method for giving a quick charge to a non-aqueous electrolytic secondary battery and the electric equipment provided with this according to the first and second embodiments of the present invention, the above described optimum charging-current value is obtained when the detected temperature is equal to, or lower than, the temperature for halting the quick charge as well as the temperature-rise rate caused by the charge is equal to, or lower than, the predetermined value. In addition, it is obtained by repeating the operation in which the predetermined increment is added to the charging current value at that time so that it can be updated. Therefore, the above described temperature decision and temperature-rise rate decision are made, so that even if the charging current flows, the temperature can be kept down so as not to reach the excessive temperature. Besides, the step of updating the optimum charging-current value is taken, so that the charging current value can be raised to such a maximum level. Therefore, as described above, the maximum charging-current value up to which it does not come to the excessive temperature even if the charging current flows can be obtained as the optimum charging-current value.

Moreover, in the method for giving a quick charge to a non-aqueous electrolytic secondary battery and the electric equipment provided with this according to the first and second embodiments of the present invention, the optimum charging-current value is corrected using the cumulative values of the lapse of time, number of charges and discharges, charge-and-discharge capacity and the like after the secondary battery is manufactured, or the secondary battery's degradation level obtained by actually measuring an OCV and a CCV, as well as the measured terminal voltage. This makes it possible to shorten the charging time more accurately.

On the basis of each embodiment described above, the present invention will be summarized as follows. Specifically, a method for quick charging a non-aqueous electrolytic secondary battery according to an aspect of the present invention, in the non-aqueous electrolytic secondary battery which includes a heat-resistant layer between a negative electrode and a positive electrode thereof, comprising the steps of: (a) detecting the temperature of the secondary battery; (b) obtaining an internal resistance value of the secondary battery which corresponds to the detected temperature of the secondary battery; (c) based on the detected temperature of the secondary battery and the obtained internal resistance value of the secondary battery, obtaining, as an optimum charging-current value, a maximum charging-current value up to which the temperature of the secondary battery does not reach an excessive temperature even if a charging current flows to the secondary battery; and (d) supplying an electric current equivalent to the obtained optimum charging-current value to the secondary battery.

According to this configuration, for example, in a method for charging a secondary battery such as a lithium-ion battery where as a standard, a CC (or constant current) charge is given up to a predetermined charge finish voltage Vf and the charge switches to a CV (or constant voltage) charge after the voltage comes to the charge finish voltage Vf, in order to realize a quick charge, the charging current value within such a CC range as described above is set to an optimum charging-current value which varies according to the temperature of the secondary battery. Then, the non-aqueous electrolytic secondary battery which includes a heat-resistant layer formed by a porous protective film or the like having a resin binder and an inorganic oxide filler between a negative electrode and a positive electrode thereof has such a characteristic that the higher its temperature becomes, the smaller the internal resistance value becomes. Hence, based on the secondary battery's temperature which is actually detected, the above described optimum charging-current value is set to a maximum charging-current value up to which it does not reach an excessive temperature even if the charging current flows to the secondary battery. The reason why the charging current value is set at the maximum level in this way is mentioned as follows. Because of the characteristic of the non-aqueous electrolytic secondary battery, if a large amount of electric current flows, the temperature rises and the internal resistance value falls so that the charge becomes quicker. However, it comes into an excessive-temperature state, and if its temperature becomes equal to, or higher than, a temperature at which a PTC protective device or such another comes into operation, for example, 80 degrees, then the charge comes to a stop, and as a result, the charging time becomes longer. On the other hand, if a small amount of electric current flows, the temperature does not rise easily and the internal resistance value remains high so that the charging time becomes longer as well. Thereafter, if the terminal voltage turns to the charge finish voltage, the CV charge or the like is given and the charge finishes.

Therefore, the secondary battery's temperature can be prevented from reaching the excessive temperature. At the same time, the charging time can be shortened. Even if the secondary battery is degraded, and thus, its internal resistance value varies according to each temperature, then the same behavior can be obtained. Consequently, the time taken for the charge can be shortened by executing similar control.

It is preferable that: step (c) includes the steps of (e) deciding whether the detected temperature of the secondary battery is equal to, or lower than, a predetermined halt temperature for halting the quick charge, (f) if the detected temperature of the secondary battery is equal to, or lower than, the halt temperature in step (e), based on the difference between two temperatures of the secondary battery which are detected at a fixed interval, calculating a temperature-rise rate of the secondary battery to be caused by the charge at the decision time, (g) deciding whether the calculated temperature-rise rate of the secondary battery is equal to, or below, a predetermined value, and (h) if the calculated temperature-rise rate of the secondary battery is equal to, or below, the predetermined value in step (g), updating the charging current value of the secondary battery by adding a predetermined increment to the charging current value at the decision time as the optimum charging-current value; and steps (a), (b), (c) and (d) are repeated at a predetermined cycle.

According to this configuration, the step (e) and the step (g) are taken, so that even if the charging current flows to the secondary battery, its temperature can be restrained from reaching the excessive temperature. Then, the step of updating the optimum charging-current value is taken, so that the charging current value can be raised to its maximum level. In this way, the maximum charging-current value up to which it does not come to the excessive temperature even if the charging current flows to the secondary battery can be obtained as the optimum charging-current value.

It is preferable that the above described method further comprises the steps of: (i) detecting a terminal voltage of the secondary battery; (j) determining a degradation level of the secondary battery; and (k) correcting the optimum charging-current value of the secondary battery in accordance with the detected terminal voltage of the secondary battery and the determined degradation level of the secondary battery.

According to this configuration, the optimum charging-current value is corrected using the cumulative values of the lapse of time, number of charges and discharges, charge-and-discharge capacity and the like after the secondary battery is manufactured, or the secondary battery's degradation level obtained by actually measuring an OCV (or open circuit voltage) and a CCV (or closed circuit voltage) as well as the measured terminal voltage V1. This makes it possible to shorten the charging time more precisely.

It is preferable that the heat-resistant layer be formed by a porous protective film including a resin binder and an inorganic oxide filler which is disposed between the negative electrode and the positive electrode of the secondary battery.

According to this configuration, the temperature can be prevented from reaching the excessive temperature, and at the same time, the charging time can be shortened. This helps makes the secondary battery more reliable and useful.

It is preferable that the above described method further comprises the steps of: (l) if the detected temperature of the secondary battery is higher than the halt temperature in step (e), deciding whether the detected temperature of the secondary battery is equal to, or higher than, a predetermined excessive temperature for reducing the charging current value of the secondary battery; and (m) in the step (l), if the detected temperature of the secondary battery is equal to, or higher than, the excessive temperature, updating the charging current value of the secondary battery by subtracting the predetermined increment from the charging current value at the decision time as the optimum charging-current value, while if the detected temperature of the secondary battery is lower than the excessive temperature, maintaining the charging current value of the secondary battery at the decision time.

According to this configuration, if the temperature of the secondary battery is equal to, or higher than, the predetermined excessive temperature for reducing the charging current value, then the charging current value is updated by subtracting the predetermined increment from the charging current value at the decision time as the optimum charging-current value. On the other hand, if the temperature of the secondary battery is lower than the excessive temperature, then the charging current value at the decision time is maintained. Therefore, the secondary battery's temperature is prevented from being higher than the excessive temperature, and thereby, the charge is prevented from stopping when the secondary battery's temperature exceeds the excessive temperature. As a result, the charging time taken for the secondary battery can be more effectively shortened.

It is preferable that the above described method further comprises the step of: (n) if the calculated temperature-rise rate of the secondary battery is above the predetermined value in the step (g), maintaining the charging current value of the secondary battery at the decision time.

According to this configuration, if the temperature-rise rate of the secondary battery exceeds the predetermined value, the charging current value at the decision time is maintained. Therefore, a shift can be easily made from the VC-charge range where the charging-current value is raised as the secondary battery's temperature-rise rate becomes higher to the CC-charge range where the charging current value is maintained.

It is preferable that in step (k), on the basis of data stored in advance in the form of a table which has as a parameter at least either of the detected terminal voltage of the secondary battery and the determined degradation level of the secondary battery, the predetermined increment be increased or decreased in accordance with the detected terminal voltage of the secondary battery and the determined degradation level of the secondary battery.

According to this configuration, the data necessary when the predetermined increment is increased or decreased in accordance with the secondary battery's terminal voltage and degradation level is stored beforehand in the table form. It can be used at any time when the predetermined increment is increased or decreased. Therefore, the optimum charging-current value for the secondary battery can be more precisely corrected.

Electric equipment according to another aspect of the present invention comprises: a battery pack provided with a non-aqueous electrolytic secondary battery having a heat-resistant layer between a negative electrode and a positive electrode thereof; a charging-current supply section for charging the non-aqueous electrolytic secondary battery; and a charge control section which controls the charging current of the charging-current supply section, wherein the battery pack includes a temperature detection section which detects the temperature of the secondary battery; and the charge control section includes a battery-temperature acquisition section which acquires the temperature of the secondary battery detected by the temperature detection section, obtains, as an optimum charging-current value, a maximum charging-current value up to which the temperature of the secondary battery does not reach an excessive temperature even if a charging current thereof flows to the secondary battery, based on the temperature of the secondary battery acquired by the battery-temperature acquisition section and an internal resistance value of the secondary battery which corresponds to the acquired temperature of the secondary battery, and sets the optimum charging-current value in the charging-current supply section.

According to this configuration, for example, in a method for charging a secondary battery such as a lithium-ion battery where as a standard, a CC (or constant current) charge is given up to a predetermined charge finish voltage Vf and the charge switches to a CV (or constant voltage) charge after the voltage comes to the charge finish voltage Vf, in order to realize a quick charge, the charging current value within such a CC range as described above is set to an optimum charging-current value which varies according to the temperature of the secondary battery. Then, the non-aqueous electrolytic secondary battery which includes a heat-resistant layer formed by a porous protective film or the like having a resin binder and an inorganic oxide filler between a negative electrode and a positive electrode thereof has such a characteristic that the higher its temperature becomes, the smaller the internal resistance value becomes. Hence, based on the secondary battery's temperature which is actually detected, the above described optimum charging-current value is set to a maximum charging-current value up to which it does not reach an excessive temperature even if the charging current flows to the secondary battery. Therefore, the secondary battery's temperature can be prevented from reaching the excessive temperature, and simultaneously, the charging time can be shortened.

This application is based on Japanese patent application serial No. 2007-039499, filed in Japan Patent Office on Feb. 20, 2007, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A method for quick charging a non-aqueous electrolytic secondary battery which includes a heat-resistant layer between a negative electrode and a positive electrode thereof, comprising the steps of:
(a) detecting the temperature of the secondary battery;
(b) obtaining an internal resistance value of the secondary battery which corresponds to the detected temperature of the secondary battery;
(c) based on the detected temperature of the secondary battery and the obtained internal resistance value of the secondary battery, obtaining, as an optimum charging-current value, a maximum charging-current value up to which the temperature of the secondary battery does not reach an excessive temperature even if a charging current flows to the secondary battery; and
(d) supplying an electric current equivalent to the obtained optimum charging-current value to the secondary battery.

2. The method according to claim 1, wherein:
step (c) includes the steps of,
(e) deciding whether the detected temperature of the secondary battery is equal to, or lower than, a predetermined halt temperature for halting the quick charge,
(f) if the detected temperature of the secondary battery is equal to, or lower than, the halt temperature in step (e), based on the difference between two temperatures of the secondary battery which are detected at a fixed interval, calculating a temperature-rise rate of the secondary battery to be caused by the charge at the decision time,
(g) deciding whether the calculated temperature-rise rate of the secondary battery is equal to, or below, a predetermined value, and
(h) if the calculated temperature-rise rate of the secondary battery is equal to, or below, the predetermined value in step (g), updating the charging-current value of the secondary battery by adding a predetermined increment to the charging-current value at the decision time as the optimum charging-current value; and
steps (a), (b), (c) and (d) are repeated at a predetermined cycle.

3. The method according to claim 2, further comprising the steps of:
(i) detecting a terminal voltage of the secondary battery;
(j) determining a degradation level of the secondary battery; and
(k) correcting the optimum charging-current value of the secondary battery in accordance with the detected terminal voltage of the secondary battery and the determined degradation level of the secondary battery.

4. The method according to claim 1, wherein the heat-resistant layer is formed by a porous protective film including a resin binder and an inorganic oxide filler which is disposed between the negative electrode and the positive electrode of the secondary battery.

5. The method according to claim 2, further comprising the steps of:
(l) if the detected temperature of the secondary battery is higher than the halt temperature in step (e), deciding whether the detected temperature of the secondary battery is equal to, or higher than, a predetermined excessive temperature for reducing the charging-current value of the secondary battery; and
(m) in step (l), if the detected temperature of the secondary battery is equal to, or higher than, the excessive temperature, updating the charging-current value of the secondary battery by subtracting the predetermined increment from the charging-current value at the decision time as the optimum charging-current value, while if the detected temperature of the secondary battery is lower than the excessive temperature, maintaining the charging-current value of the secondary battery at the decision time.

6. The method according to claim 2, further comprising the step of:
(n) if the calculated temperature-rise rate of the secondary battery exceeds the predetermined value in step (g), maintaining the charging-current value of the secondary battery at the decision time.

7. The method according to claim 3, wherein in step (k), on the basis of data stored in advance in the form of a table which has as a parameter at least either of the detected terminal voltage of the secondary battery and the determined degradation level of the secondary battery, the predetermined increment is increased or decreased in accordance with the detected terminal voltage of the secondary battery and the determined degradation level of the secondary battery.

8. Electric equipment comprising:
a battery pack provided with a non-aqueous electrolytic secondary battery having a heat-resistant layer between a negative electrode and a positive electrode thereof;
a charging-current supply section for charging the non-aqueous electrolytic secondary battery; and
a charge control section which controls the charging current of the charging-current supply section,
wherein
the battery pack includes a temperature detection section which detects the temperature of the secondary battery, and
the charge control section includes a battery-temperature acquisition section which acquires the temperature of the secondary battery detected by the temperature detection section, obtains, as an optimum charging-current value, a maximum charging-current value up to which the temperature of the secondary battery does not reach an excessive temperature even if a charging current flows to the secondary battery, based on the temperature of the secondary battery acquired by the battery-temperature acquisition section and an internal resistance value of the secondary battery which corresponds to the acquired temperature of the secondary battery, and sets the optimum charging-current value in the charging-current supply section.
